(19) United States
(12) Patent Application Publication
(10) Pub. No.: US 2014/0000380 A1
(43) Pub. Date: Jan. 2, 2014

(54) METHOD AND APPARATUS FOR DETERMINING GEOMETRY DEFORMATION IN ROTATING COMPONENTS

(71) Applicant: ALSTOM Technology Ltd., Baden (CH)

(72) Inventors: Slawomir Slowik, Koblenz (CH); Thomas Tscharner, Turgi (CH); Piotr Bednarz, Spreitenbach (CH); Michal Tomasz Prugarewicz, Ruetihof (CH)

(21) Appl. No.: 13/926,733

(22) Filed: Jun. 25, 2013

Related U.S. Application Data
(60) Provisional application No. 61/664,877, filed on Jun. 27, 2012.

(51) Int. Cl. G01L 1/24

(52) U.S. Cl. CPC G01L 1/24
USPC 73/800

(57) ABSTRACT

A method is provided for measuring geometry deformations of a turbine component, rotor groove or blade root. The method includes providing the turbine component, rotor groove or blade root, respectively, with at least one measuring mark; using the at least one mark as a reference point in determining, in a first measurement, a length on the turbine component or rotor groove or blade root, respectively, before placing the turbine into service. The method also includes operating the turbine for a period of time; determining, in a second measurement, the length on the turbine component, rotor groove or blade root, using the at least one measuring mark as a reference point, after said operating period; comparing the measured lengths of the first and second measurements; and determining an amount of creep deformation in the turbine component, rotor groove or blade root, respectively, based on a difference between the measured lengths.

### CROSS REFERENCE TO RELATED APPLICATIONS

This application claims benefit of U.S. Provisional Patent Application No. 61/664,877, filed Jun. 27, 2012, the entire contents of which are incorporated by reference herein as if fully set forth.

### FIELD OF THE INVENTION

The present invention relates to the technology of turbines. It refers to a method for measuring deformation behavior of rotating components of a compressor stage or turbine stage, such as are used, for example, in compressors, gas turbines or steam turbines.

### BACKGROUND

Rotors and moving blades of heavy-duty gas and high-pressure steam turbines are exposed to high mechanical load by centrifugal forces and to a very high temperature. The temperatures are generally above transition temperatures of the materials involved, so that time-dependent plastic expansion, so-called creeping, is an essential factor, which limits the useful life of the respective components.

Therefore, it is important, in the operation of a plant, to determine the creep behavior or the remaining useful life of costly components of a turbine, such as rotors and moving blades. In this context, on the one hand, safety aspects, and, on the other hand, financial aspects play an important part. Thus, a late replacement of the components leads to a higher safety risk within the plant, while a too early replacement of the components brings about unnecessary costs. It is therefore important, during the operation of a plant of this type, to monitor and estimate the creep behavior of rotating components in compressor stages and turbine stages and to estimate correctly the remaining useful life of these components.

Presently, in order to determine creep measurement, a rotor 10 comprises a rotor groove 11, as shown in FIG. 1, which has a length D from its bottom 12 that is measured twice, first when it is brand-new, by means of a so-called “zero measurement”, and a second time during a periodic inspection interval (e.g. during C-inspection). The measurement is done with measuring balls 13. If creep deformation occurs in the rotor groove 11, the length D will increase over time. After a certain operation period, the length D will be greater than the zero measurement length. By comparing the difference between the second measurement of length D to the zero measurement of length D, the creep lifetime deterioration can be determined, generally by using the Finite Element Method (FEM), which uses viscoplastic material models.

However, models of this type require an accurate knowledge of the material constants, boundary conditions and operating conditions, to which the components are subjected during operation. The accuracy of prognosis of these computational models is very limited because of the uncertainties in the specification of these parameters. Thus, the external boundary conditions, in particular the material temperatures during operation, cannot always be specified with sufficient accuracy.

Further there are also accuracy problems, which arise from the surface quality, where the measuring ball 13 is located. Before the measurements can be carried out, all of the surfaces of the rotor groove 11 must be cleaned. The cleaning of the rotor groove 11 is a time- and labor-intensive procedure requiring skilled technicians. After the surfaces are cleaned, the measurements are done manually using calipers. The use of calipers to carry out the measuring by hand leads to certain inaccuracies since the measurements cannot be performed using the exact same points each time.

Document JP 2004044423 discloses a method to detect the state of advancement of creep of a moving blade without disassembling an engine. A notch formed by cutting out ranging from the tip to a specified depth is provided in a seal serration part on a chip shroud to form the moving blade with a creep detection mark. When the creep occurs and advances in the moving blade, the length of the moving blade is extended by a load at the time of rotation, and the seal serration part is gradually worn by its rubbing with a case. Accordingly, the depth of the notch is set so that the advancement of creep of the moving blade can correspond to the worn amount of the seal serration part before the moving blade is led to a breakage. The moving blade with the creep detection mark is inspected with a bore scope in the state of being assembled in a gas turbine engine, and the state of advancement of the creep of the moving blade is determined by whether or not the notch can be viewed on the seal serration part.

An improvement in prognosis can be achieved by the prognosis being checked by means of concrete measurements of the creep damage of the monitored component after various operation periods and, if appropriate, being corrected by adaption of the parameters. This makes it necessary, however, to determine the creep behavior or creep damage of the component by means of nondestructive test methods.

At the present time, however, there are no nondestructive test methods available, which could provide reliable evidence on the creep damage of a component at an early operational stage.

In summary, there have been heretofore no satisfactory methods for either monitoring or determining the remaining creep life of a rotating component of a turbine stage or compressor stage.

### SUMMARY

It is an object of the present invention to provide a method for measuring geometry deformations of a turbine component, especially of a turbine rotor groove or blade root, which avoid the disadvantages of the prior art methods, is easy to apply and gives results of high precision.

This object is obtained by a method according to claim 1.

According to the invention, the method for measuring geometry deformations of a turbine component, especially of a rotor groove or blade root, the method comprises the steps of:

a. providing the turbine component, or rotor groove or blade root, respectively, with at least one measuring mark;
b. using the at least one measuring mark as a reference point in determining, in a first measurement, a length on said turbine component or rotor groove or blade root, respectively, prior to the turbine being placed into service;
c. operating the turbine for a period of time;
d. determining, in a second measurement, said length on said turbine component or rotor groove or blade root, respectively, using again said at least one measuring mark as a reference point, after said operating period;
e. comparing the measured lengths of said first and the second measurement; and
f. determining an amount of creep deformation in said turbine component or rotor groove or blade root, respectively, based on a difference between said measured lengths.

According to an embodiment of the inventive method said turbine component, or rotor groove or blade root, respectively, is provided with a plurality of measuring marks being distributed on a common surface of said turbine component, or rotor groove or blade root, respectively.

According to another embodiment of the inventive method said turbine component, or rotor groove or blade root, respectively, is provided with said at least one measuring mark, when it is newly manufactured.

According to a further embodiment of the inventive method said at least one measuring mark is done as a permanent measuring mark.

Specifically, said at least one measuring mark is done by laser engraving.

According to another embodiment of the inventive method said at least one measuring mark is recognizable by the naked eye during inspection of the turbine.

According to just another embodiment of the inventive method said first and second measurements are done by optical methods.

Specifically, said first and second measurements are done by using an optical sensor.

Alternatively, said first and second measurements are done by using a laser sensor.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 shows an exemplary rotor groove of a rotor and indicates a prior art method of measuring depth variation of said groove;

FIG. 2 shoes an exemplary fir tree attachment part of a rotor in perspective view with various measuring marks according to an embodiment of the present application;

FIG. 3 shows a view in direction A of FIG. 2;

FIG. 4 shows a view in direction B of FIG. 2; and

FIG. 5 shows a view in direction C of FIG. 2.

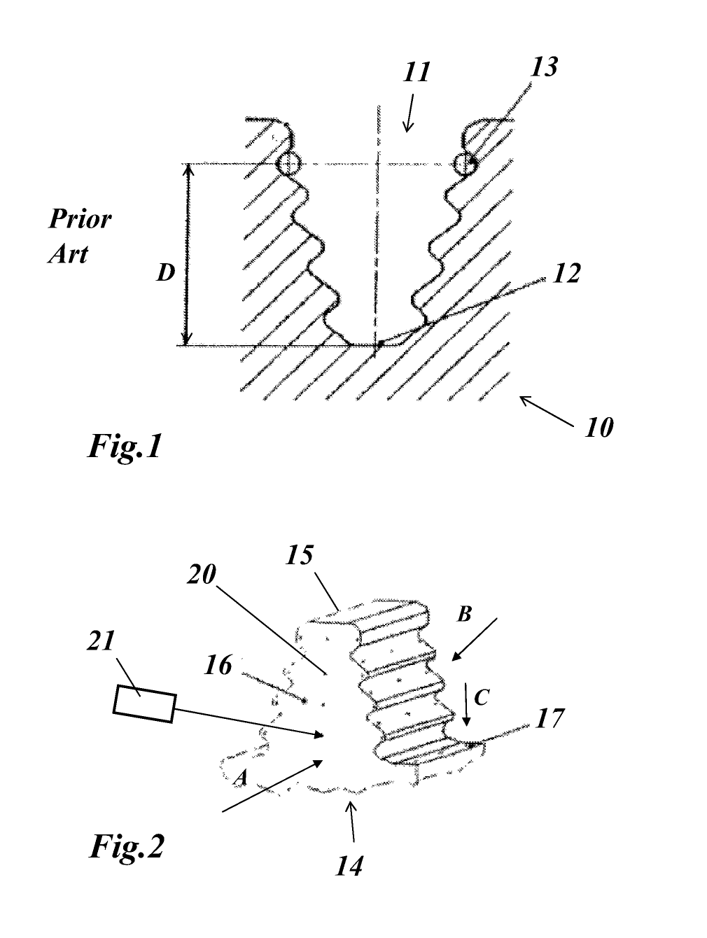

### DETAILED DESCRIPTION OF THE PREFERRED EMBODIMENTS

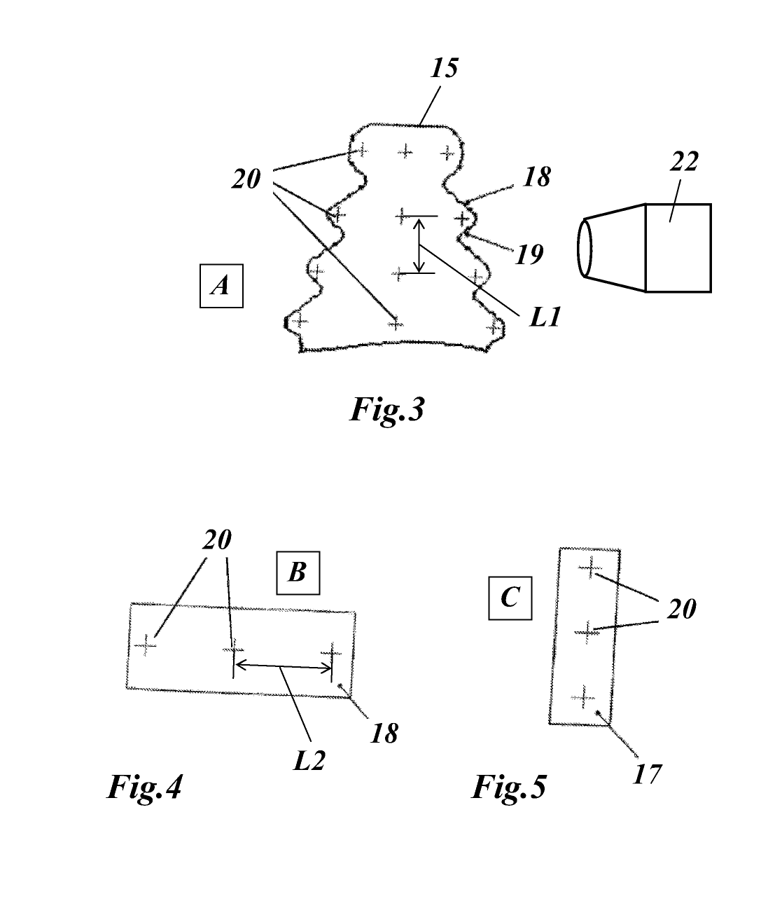

As shown in FIG. 2, a rotor 14 is provided with rotor grooves for receiving respective rotor blades. A fir tree attachment part between adjacent grooves is indicated generally by reference numeral 15. The grooves are shown having a general fir-tree configuration to accept a respective root of a blade (not shown) in a conventional manner. Although a fir-tree configuration is shown, it should be understood that the invention can be applied to other types of configurations, e.g. hammer root, straight and curved fir-tree, etc. The groove includes (see FIG. 3) non-contact surfaces 18 and contact surfaces 19 as well as a bottom portion 17 (FIG. 2).

According to the invention, the fir tree attachment part 15 and adjacent grooves are marked in various locations on their surfaces with measuring marks 20. These measuring marks 20 are preferably permanent and are formed by laser engraving with a laser engraving tool 21 (FIG. 2), or other suitable method. The measuring marks 20 serve as reference points for carrying out first and second measurements in order to determine any possible creep after the rotor 14 has been used. The marking of the fir tree attachment part 15 and rotor grooves by laser engraving or other suitable method should be performed preferably at the time of manufacture of the rotor 14. It should be noted that a blade root could also be marked in a similar fashion. The positions of the measuring marks 20 are specific to the situation and are placed on faces where low stresses are exhibited. By placing the measuring marks 20 on low stress faces, cooling and mechanical behavior of the rotor or blade are not affected.

The distribution of the measuring marks 20 is shown in greater detail in FIGS. 3-5, which depict the views along arrows A-C in FIG. 2. The measuring marks 20 are placed in such positions and are sized so that they are recognizable to the naked eye during periodic inspections. As a result, at every inspection of the machine the pattern is exactly measured and deformations are identified by comparing the respective measurement results with prior measurements. The measurements are generally performed by optical or laser measurement methods, for example by means of an optical sensor 22 (FIG. 3). By ensuring that the measuring marks 20 are identical at each measurement, a more accurate measurement, as compared with current methods, is possible. Owing to this greater accuracy, risk predictions of creep damage for rotors are greatly improved.

In the method of the present invention, at least one measuring mark is provided on the turbine rotor groove (or blade root), and using the at least one measuring mark as a reference in determining in a first measurement a length on the rotor groove (or blade root) prior to the turbine being placed into service. The turbine is then placed into service for a period of time and afterwards, a second measurement, using the at least one measuring mark as a reference, of the same length on the rotor groove (or blade root) after operating of the turbine blade for the period of time is determined. The second measurement is compared to the first measurement, and an amount of creep deformation in the rotor groove (or blade root) is determined based on a difference between the first measurement and the second measurement.

The method of the present invention provides a fast and reliable way to obtain important and more accurate field data, while minimizing down time. The methodology of the method can be applied in all types of rotor grooves and blade roots independent of the design. Moreover, the method can also be applied to other components, e.g. compressor, gas turbine or steam turbine casings, in which other types of measurements, e.g. bending or ovalization, are carried out.

It is understood, therefore, that this invention is not limited to the particular embodiments disclosed, but is intended to cover all modifications which are within the spirit and scope of the invention as defined by the appended claims; the above description; and/or shown in the attached drawings.

### LIST OF REFERENCE NUMERALS

10 rotor
11 rotor groove
12 bottom (rotor groove)
13 measuring ball
14 rotor
15 fir tree attachment part (rotor)
16 front/back surface
17 bottom (rotor groove)
18 non-contact surface
19 contact surface
20 measuring mark
21 laser engraving tool
22 optical sensor
A-C viewing direction
D length
L1, L2 length

What is claimed is:

1. A method for measuring geometry deformations of a turbine component (14), rotor groove or blade root, the method comprising the steps of:
providing the turbine component (14), or rotor groove or blade root, respectively, with at least one measuring mark (20);
using the at least one measuring mark (20) as a reference point in determining, in a first measurement, a length (L1, L2) on said turbine component (14) or rotor groove or blade root, respectively, prior to the turbine being placed into service;
operating the turbine for a period of time;
determining, in a second measurement, said length (L1, L2) on said turbine component (14) or rotor groove or blade root, respectively, using again said at least one measuring mark (20) as a reference point, after said operating period;
comparing the measured lengths (L1, L2) of said first and second measurements; and
determining an amount of creep deformation in said turbine component (14) or rotor groove or blade root, respectively, based on a difference between said measured lengths.

2. The method as claimed in claim 1, wherein said turbine component (14), or rotor groove or blade root, respectively, is provided with a plurality of measuring marks (20) being distributed on a common surface of said turbine component (14), or rotor groove or blade root, respectively.

3. The method as claimed in claim 1, wherein said turbine component (14), or rotor groove or blade root, respectively, is provided with said at least one measuring mark (20), when the turbine component (14), rotor groove or blade root is newly manufactured.

4. The method as claimed in claim 1, wherein said at least one measuring mark (20) is done as a permanent measuring mark.

5. The method as claimed in claim 4, wherein said at least one measuring mark (20) is done by laser engraving (21).

6. The method as claimed in claim 1, wherein said at least one measuring mark (20) is recognizable by the naked eye during inspection of the turbine.

7. The method as claimed in claim 1, wherein said first and second measurements are done by optical methods.

8. The method as claimed in claim 7, wherein said first and second measurements are done by using an optical sensor (22).

9. The method as claimed in claim 7, wherein said first and second measurements are done by using a laser sensor.
